(19) United States
(12) Patent Application Publication
(10) Pub. No.: US 2025/0287123 A1
(43) Pub. Date: Sep. 11, 2025

(54) SINGLE PHOTON AVALANCHE DIODE MACROPIXEL

(71) Applicant: The University Court of The University of Edinburgh, Edinburgh (GB)

(72) Inventor: Robert Henderson, Edinburgh (GB)

(21) Appl. No.: 18/858,232

(22) PCT Filed: Apr. 21, 2023
(86) PCT No.: PCT/GB2023/051062

§ 371 Date: Oct. 18, 2024

(30) Foreign Application Priority Data
Apr. 22, 2022 (GB) 2205893.7

(51) Int. Cl. H04N 25/773; H04N 25/47; H04N 25/707; H04N 25/76; H04N 25/771

(52) U.S. Cl. CPC H04N 25/773; H04N 25/47; H04N 25/707; H04N 25/771; H04N 25/7795

(57) ABSTRACT

A macropixel is disclosed. The macropixel comprises a plurality of pixels, each pixel comprising a Single Photon Avalanche Diode (SPAD). The macropixel also comprises a memory configured to store: a plurality of counts, each count associated with a pixel of the plurality of pixels; and a plurality of saturation bits, each saturation bit associated with a count of the plurality of counts. The macropixel also comprises saturation detection circuitry configured to gate a recharge of each SPAD based on a state of the respective saturation bit.

### TECHNICAL FIELD OF THE DISCLOSURE

The present disclosure is in the field of SPAD-based pixels, and in particular relates to macropixels comprising a plurality of SPAD-based pixels for use in image sensors.

### BACKGROUND

Single Photon Avalanche Detector (SPAD) based sensors may typically be implemented in a variety of applications including, for example, LiDAR, time-of-flight (ToF) and 3D imaging applications.

Characteristics and operation of SPADs may be influenced by an underlying semiconductor technology that is used to implement the SPADs, and also by associated circuitry for controlling and sensing SPAD operation and recording SPAD events, e.g. photon strikes. For example, a dynamic range, spatial resolution, signal-to-noise ratio and/or bit count of a SPAD-based device may depend, at least in part, on an underlying semiconductor technology node in which the SPADs are fabricated and/or associated measurement and storage circuitry.

In some examples, circuitry required to readout and/or store a state of a SPAD may substantially influence a size, cost, power consumption, and general performance of the SPAD-based device.

Use of SPAD-based pixels in applications such as image sensing has been limited to some extent by such characteristics of SPAD-based pixels and their operation.

For example, implementation of a cost-effective image sensor using SPAD-based pixels, wherein the SPAD-based image sensor has comparable performance to known megapixel CMOS image sensors, would require implementation of SPAD-based pixels exhibiting a high photon counting dynamic range, yet with a small enough footprint to ensure sufficiently low power consumption and commercial viability, wherein said commercial viability may be largely related to a number of megapixels in standard optical lens formats for low z-height embedded cameras suitable for mobile battery-powered applications.

Semiconductor technology nodes, such as sub-30 nanometre nodes, that may be required to implement circuitry that meets such stringent size, power and performance requirements may be prohibitively expensive. As such, design of SPAD-based image sensor implementations may require sub-optimal compromises in terms of spatial resolution, temporal resolution, bit count, power requirements, and/or signal-to-noise ratio.

In particular, implementation of counters for counting SPAD events may substantially impact size, power and performance of a SPAD-based photon counting image sensor.

Known counter solutions may include either digital bit counters or analogue bit counters.

Digital bit counters generally employ N flip-flops for a N-bit counter and, despite process scaling to advanced CMOS fabrication nodes, e.g. sub 30 nanometre nodes, such counters may still occupy a substantial area due to their large transistor counts, thereby limiting a pitch and hence resolution of any image array implemented using such digital bit counters.

An alternative approach is the use of analogue counters which may beneficially shrink the pixel pitch and reduce power. However, such analogue counters may be prone to current leakage, mismatch errors, manufacturing process variations, and are not easily portable between different CMOS technology nodes.

It is therefore desirable to provide a highly integrated SPAD-based sensor suitable for implementation in megapixel image sensing applications. Furthermore, it is desirable that such a SPAD-based sensor be suitable for manufacture in a cost-effective semiconductor process node, yet still provide sufficient dynamic range, spatial resolution and signal-to-nose ratio to be competitive with known CMOS megapixel imagers. It is desirable that such a SPAD-based sensor be implemented predominantly using digital circuitry, to avoid the above-described shortcomings of an analogue solution. Furthermore, it is highly desirable that such a SPAD-based sensor meets stringent low-power requirements.

It is therefore an aim of at least one embodiment of at least one aspect of the present disclosure to obviate or at least mitigate at least one of the above identified shortcomings of the prior art.

### SUMMARY

The present disclosure is in the field of SPAD-based pixels, and in particular relates to macropixels comprising a plurality of SPAD-based pixels for use in image sensors.

According to a first aspect of the disclosure, there is provided a macropixel comprising a plurality of pixels, each pixel comprising a Single Photon Avalanche Diode (SPAD). The macropixel also comprises a memory configured to store: a plurality of counts, each count associated with a pixel of the plurality of pixels; and a plurality of saturation bits, each saturation bit associated with a count of the plurality of counts. The macropixel also comprises saturation detection circuitry configured to gate a recharge of each SPAD based on a state of the respective saturation bit.

The term ‘macropixel’ will be understood to refer to an optical device comprising a plurality of pixels, e.g. two or more pixels.

The term ‘pixel’ will be understood to refer to a SPAD-based pixel, e.g. a SPAD together with circuitry associated with that SPAD. For example, such associated circuitry may comprise circuitry for sampling and holding a voltage level, circuitry for resetting the SPAD, circuitry for quenching the SPAD, and/or the like, as described in more detail below.

The term “Single Photon Avalanche Diode” will be understood to refer only to the physical SPAD device itself, and excludes additional circuitry that, collectively, may form a SPAD-based pixel as described above.

The term “count” will be understood to refer to a value, e.g. a value that may be used with associated counter circuitry to implement a counter. The count may be a value that is incremented, decremented or otherwise advanced to a next known state by associated circuitry. In further examples, and as described in more detail below, the count may be a value that is sequentially incremented, decremented or adjusted to one of a defined number of known states.

In a non-limiting example, a count may correspond to a word stored in memory.

Advantageously, use of a memory, e.g. SRAM or DRAM memory cells, may reduce an overall footprint and power consumption of the macropixel when compared to hardware counters, e.g. flip-flop based binary counters as may be implemented in prior art pixels. That is, an overall transistor count of a memory based macropixel may be substantially less than a transistor count associated with a hardware counter based macropixel, thereby contributing to lower power consumption and size. In yet further example, other RAM-types may be implemented, such as Phase-Change RAM (PCRAM), Synchronous Dynamic Ram (SDRAM), spin-torque transfer magnetic RAM (STT-MRAM), or the like.

Advantageously, by gating a recharge of each SPAD based on a state of the respective saturation bit, a power consumption of the macropixel may be substantially reduced, as described in more detail below.

Advantageously, memory and saturation detection circuitry that is fully digital and is suitable for implementation in a compact macropixel, wherein the digital circuitry may be optimally stacked below the SPADs of the pixels.

Advantageously, the fully digital solution described in more detail below enables implementation of macropixels that do not require analogue-to-digital circuitry, as may be implemented in prior art pixels.

Advantageously, the disclosed macropixel may enable optical sensing with a high dynamic range using low power, digital pixels in a compact size that is suitable for implementation in a low cost semiconductor fabrication technology node. That is, the disclosed macropixel avoids the need to move to increasingly advanced semiconductor fabrication technology nodes to implement a pixel meeting stringent low-power and performance requirements, thereby minimising costs and design cycle times.

The saturation detection circuitry may be configured to gate a recharge of each SPAD when the respective saturation bit indicates the associated count has saturated.

The saturation detection circuitry may be configured to gate a recharge of each SPAD when the respective saturation bit indicates the associated count has reached a threshold value.

Advantageously, power consumption may be reduced by gating a recharge of each SPAD after a count associated with the SPAD has saturated or reached the threshold value.

In embodiments, saturation of the count may correspond to a value of the count reaching a maximum value.

In embodiments, saturation of the count may correspond to a value of the count rolling over or returning to an initial value.

In embodiments, saturation of the count may correspond to a value of the count sequencing through all possible states.

In embodiments, the threshold value may be user programmable.

While the recharge of one or more SPADs in one or more pixels of the plurality of pixels is gated, the associated one or more counts may be used to indicate a time since the respective saturation bit indicated the count saturated and/or reached a threshold value.

That is, in embodiments a number of refresh cycles, e.g. cycles in which a SPAD would have been recharged if it had not saturated, may be counted. Advantageously, such extended counting of refresh cycles even after gating of the recharge of the SPAD may be used to effectively extend a dynamic range of the pixel, as described in more detail below.

While the recharge of one or more SPADs in one or more pixels of the plurality of pixels is not gated, the associated one or more counts may be used to indicate a number of detected photons.

Advantageously, each count may correspond to a photon count of an associated pixel. It will be understood that the ‘number of detected photons’ may correspond to a number of SPAD events, e.g. a number of avalanche current triggering events, rather than to an exact number of photons incident upon the SPAD.

Access to the memory by each pixel may be provided on a time-multiplexed basis.

Each SPAD may be recharged on a time multiplexed basis while recharging of the SPAD is not gated.

Advantageously, power consumption may be significantly reduced by implementing time-multiplexing. Furthermore, an amount of logic, e.g. a transistor count, can be minimised, as described in more detail below with reference to the accompanying drawings.

In embodiments, a high gain mode of each SPAD, e.g. a mode in which the SPAD is recharged into the Geiger mode suitable for detecting photon strikes, is used with a relatively low duty cycle, with a minimum time duration required to achieve a necessary signal-to-noise ratio.

The time-multiplexed basis may be a round-robin basis.

That is, in use each SPAD may be recharged and/or each count stored in the memory may be accessed, on average, a substantially equal amount of times.

Gating the recharge of each SPAD may comprise configuring at least one transistor in the respective pixel to retain the SPAD in a sub-Geiger mode.

The sub-Geiger mode will be understood to be a mode in which the respective SPAD is biased below its reverse-bias breakdown voltage

Advantageously, holding a SPAD at a voltage insufficient for Geiger mode breakdown, e.g. below its reverse-bias breakdown voltage, may reduce a power consumption of the SPAD, and may extend a lifetime of the SPAD. For example, power consumption of a SPAD may be relatively high compared to a pinned photodiode because a relatively large charge may be consumed by the avalanche multiplication process following a photon strike. By holding the SPAD below the reverse-bias breakdown voltage, the avalanche multiplication process may be avoided.

Each pixel may comprise at least one transistor configurable to hold the respective SPAD in a high impedance state while the SPAD is biased in a Geiger mode.

In embodiments, each SPAD may be periodically reset, wherein following reset the SPAD may be left in the Geiger mode while in the high-impedance state, thereby advantageously reducing an overall power consumption.

The macropixel may be configured such that when a photon triggers a SPAD, the SPAD discharges its internal capacitance, thereby taking the excess bias voltage of the SPAD below a breakdown voltage.

Advantageously, when an avalanche-event-triggering photon strike occurs, e.g. a photon is absorbed to create an electron-hole pair that triggers an avalanche event, the respective SPAD may discharge its own capacitance, thereby taking the excess bias below the breakdown level, e.g. into the sub-Geiger mode, effectively achieving self-quenching.

Each pixel may comprise a recharge transistor configurable to recharge the respective SPAD to the Geiger mode.

Each pixel may comprise a sample and hold circuit for sampling and holding a voltage corresponding to a state of the respective SPAD.

Advantageously, in embodiments the above described pixel, which may implement both the transistor configurable to hold the respective SPAD in a high impedance state while the SPAD is biased in a Geiger mode together with the sample and hold circuit for sampling and holding a voltage corresponding to a state of the respective SPAD, may effectively realise a dynamic D-type sampler in a compact area.

The macropixel may comprise a shared memory increment or decrement circuit. The macropixel may comprise a time-multiplexed memory increment or decrement circuit. The macropixel may comprise a shared and time-multiplexed memory increment or decrement circuit configured to increment or decrement respectively each count of the plurality of counts.

That is, a shared increment or decrement circuit may be configured to selectively increment or decrement, or otherwise advance, each stored count in a time-multiplexed manner, as described in more detail below. Advantageously, an effective area-per-SPAD of circuitry related to increment/decrement/advancement of a count and any associated saturation detection may be substantially minimised by a degree of sharing between counts, e.g. by the amount of counts sharing the memory increment or decrement circuit.

Furthermore, time-multiplexing of shared circuitry may also help reduce power consumption. That is, the shared circuitry may be associated with each count of the plurality of counts on a time-multiplexed basis, e.g. with a dedicated time-slot for each count, thereby avoiding duplication of said circuitry.

In example embodiments, such time-multiplexing may be on a round-robin basis. However, the disclosure is not limited to such embodiments, and other scheduling methods may be implemented.

Each count may correspond to a value for a binary counter.

That is, in an example, a shared increment or decrement circuit may be configured to selectively increment or decrement each stored count using binary arithmetic, as described in more detail below with reference to the disclosed embodiments.

In example embodiments, such a shared increment or decrement circuit may be implemented as a chain of full-adder circuits.

Each count may correspond to a value representing a state of a Linear Feedback Shift Register (LFSR).

That is, in an example, a shared increment or decrement circuit may be configured to selectively advance each stored count to a next state of an LFSR, as described in more detail below with reference to the disclosed embodiments.

In embodiments, each LFSR may require a XOR feedback and a shift operation, which may reduce an overall transistor count in comparison to a binary counter implementation, event when taking into account implementation of any LFSR-to-binary decode circuitry.

Advantageously, an LFSR may be substantially smaller and may consume less power and/or circuit area than a binary counter.

Furthermore, an LFSR may reduce a need for a higher levels of time-multiplexed sharing of access to the memory, which may increases an availability of the memory to each SPAD, thereby advantageously increasing the dynamic range the macropixel.

Although examples of a binary counter and a LFSR are described herein, it will be appreciated that the disclosure is not limited to such specific embodiments, and embodiments implementing alternative or additional circuits capable of incrementing and/or decrementing a count and/or advancing a code or a state may be implemented.

The macropixel may comprise processing circuitry configured to readout each count and each associated saturation bit at the end of a frame time.

In embodiments, readout may be achieved by means of a “rolling shutter” technique, e.g. a line-by-line readout of the memory.

The processing circuitry may be configured to readout each count by clocking the respective pixel for at least a number of cycles corresponding to a number of memory cells associated with the pixel, while holding the respective pixel in reset.

Advantageously, this may allow read-out of each count and saturation bit in memory, e.g. each row in the memory, while also resetting the memory at the same time.

The processing circuitry may be additionally configured to readout the saturation bit associated with each count.

Advantageously, processing circuitry may use the saturation bit to implement an extended counting dynamic range extension scheme.

That is, in an example embodiment based on an LFSR implementation, the saturation detection circuitry may detect a count being an all zero state of an LFSR code associated with a pixel, thereby indicating that the LFSR code has counted through all possible states and is about to “wrap-around”, e.g. saturate.

Similarly, in an example embodiment based on binary counting, the saturation detection circuitry may detect a count being an all one state of a binary code associated with a pixel, thereby indicating that the binary count has counted through all possible states and is about to “wrap-around”, e.g. saturate.

When this occurs, the saturation bit may be set for the respective pixel, indicating that the respective SPAD has reached saturation of its LFSR or binary counter.

As described above, the saturation bit may be used to gate a recharge of the respective SPAD. As such, the respective SPAD is not reset low again and therefore may maintain a high state, e.g. a triggered state.

This, in turn, may cause further increments or decrements of a stored count, e.g. a binary count or an LFSR code, on every refresh cycle.

However, processing circuitry may use the saturation bit to determine that the stored count since the saturation bit was set represents a “time since saturation”. As such, a dynamic range of the pixel may also be increased without significant dips in a signal-to-noise ratio.

That is, when the saturation bit associated with a respective count is set and when a recharge of the associated SPAD is gated, the processing circuitry may be configured to use the respective count to as an indication of round-robin refresh cycles since the saturation bit was set.

The memory may comprise an array of Static Random Access Memory (SRAM) cells.

Advantageously, an SRAM-based implementation may represent a trade-off between a relatively high-density memory compared to a flip-flop or logic based counter implementation, with low power consumption, e.g. no refresh cycles that may be associated with a DRAM.

The memory may comprise an array of Dynamic Random Access Memory (DRAM) cells.

Advantageously, DRAM may represent an extremely high density memory, for example having as few as three transistors per memory cell, thereby enabling implementation of a highly compact and integrated macropixel.

The macropixel may comprising refresh circuitry for refreshing the DRAM cells.

Advantageously, the DRAM may be refreshed without affecting a stored count.

The refresh circuitry may be configured to increment the count by zero if the respective SPAD has not been triggered.

The refresh circuitry may be configured to add a predetermined number of extra refresh cycles to the count for subsequent subtraction by processing circuitry.

Advantageously, the DRAM may be refreshed by affecting a stored count in a known way.

The macropixel may be formed as a monolithic device.

In examples, the macropixel may be formed in a CMOS process.

The memory may be formed in a region of a substrate. The plurality of pixels may be formed directly over the memory. The plurality of SPADs may be formed directly over the memory.

Advantageously, the above described macropixels, and in particular the memory and/or circuitry of the above-described macropixels, may be sufficiently compact that a SPAD array, or an array of the SPAD based pixels, may be formed directly over the memory and/or circuitry.

According to a second aspect of the present disclosure, there is provided an image sensor comprising an array of macropixels according to the first aspect.

Advantageously, implementing an image sensor using SPADs instead of pinned photodiodes as may commonly be used in CMOS image sensors, may result in a sensor exhibiting an extremely high dynamic range and sensitivity.

In embodiments, the array of macropixels may be used to implement a ‘megapixel array’, e.g. an array comprising hundreds of thousands or millions of pixels.

According to a third aspect of the present disclosure, there is provided a proximity sensor or a time-of-flight sensor comprising at least one macropixel according to the first aspect.

Advantageously, the above-described time-multiplexed mode of operation, for example wherein each SPAD may be reset in a round-robin basis, may enable implementation of distance measurements.

For example, in an embodiment of a macropixel comprising N×SPADs, and assuming each SPAD is held in reset for 1/N^{th} of a cycle, it may be assumed that a laser pulse return falling in the i^{th} SPAD's reset window will have no signal from distances between i/N and i+1/N of the distance range. As such, processing circuitry may perform an indirect Time-of-Flight type of distance calculation.

The above summary is intended to be merely exemplary and non-limiting. The disclosure includes one or more corresponding aspects, embodiments or features in isolation or in various combinations whether or not specifically stated (including claimed) in that combination or in isolation. It should be understood that features defined above in accordance with any aspect of the present disclosure or below relating to any specific embodiment of the disclosure may be utilized, either alone or in combination with any other defined feature, in any other aspect or embodiment or to form a further aspect or embodiment of the disclosure.

### BRIEF DESCRIPTION OF THE PREFERRED EMBODIMENTS

These and other aspects of the present disclosure will now be described, by way of example only, with reference to the accompanying drawings, wherein:

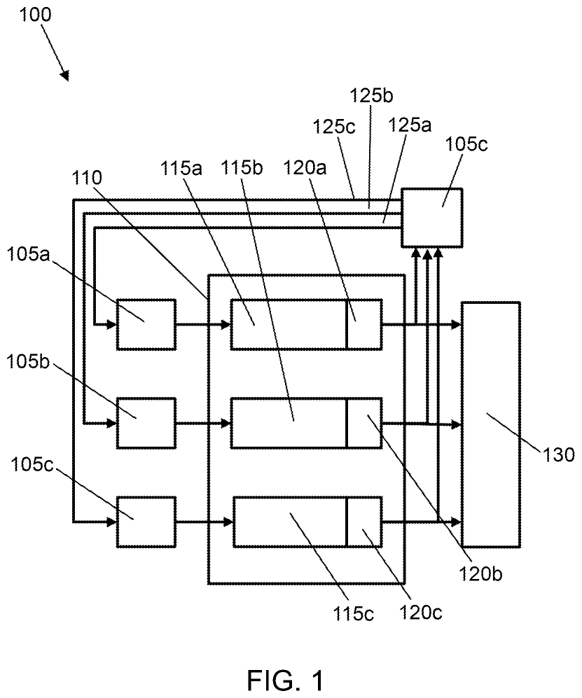

FIG. 1 depicts a block diagram of a macropixel according to an embodiment of the disclosure;

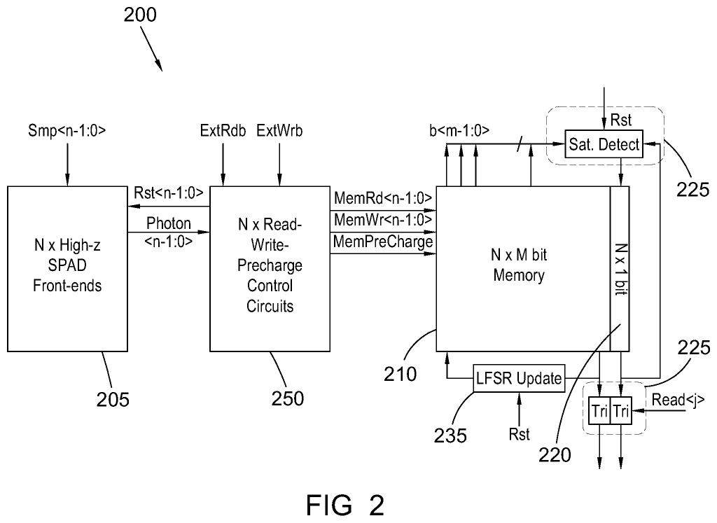

FIG. 2 depicts a block diagram of a macropixel according to a further embodiment of the disclosure;

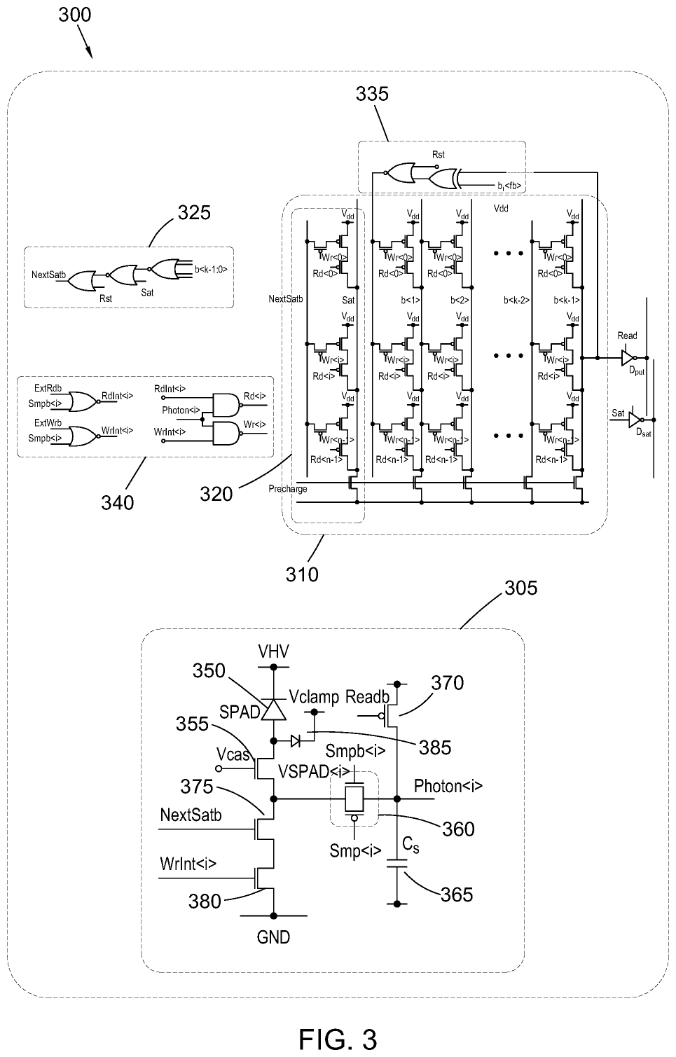

FIG. 3 depicts a circuit diagram of a macropixel implemented using a LFSR and a DRAM, according to a further embodiment of the disclosure;

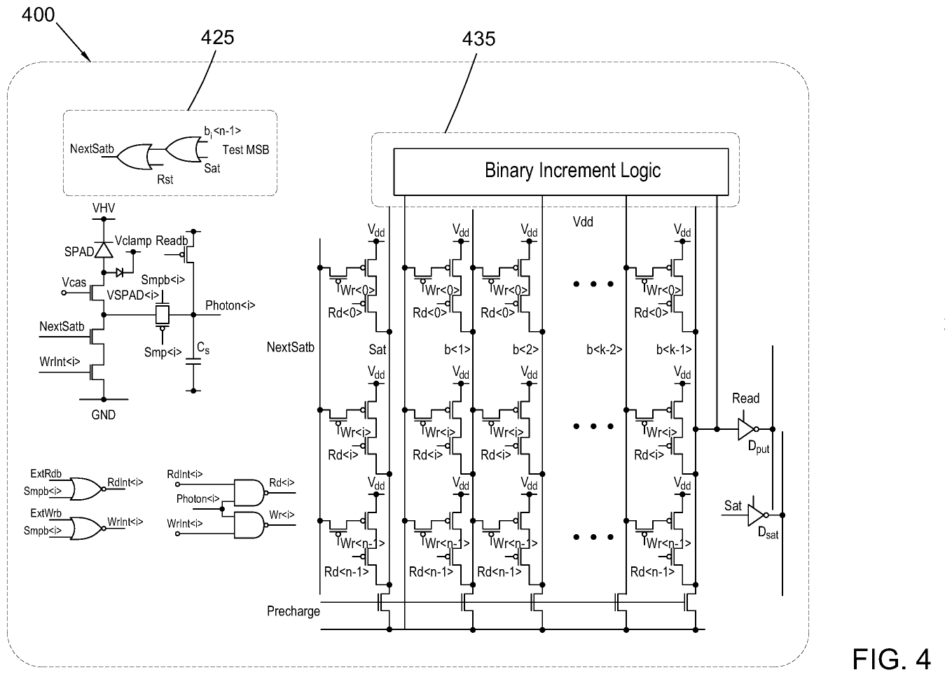

FIG. 4 depicts a circuit diagram of a macropixel implemented using a binary increment circuit and a DRAM, according to a further embodiment of the disclosure;

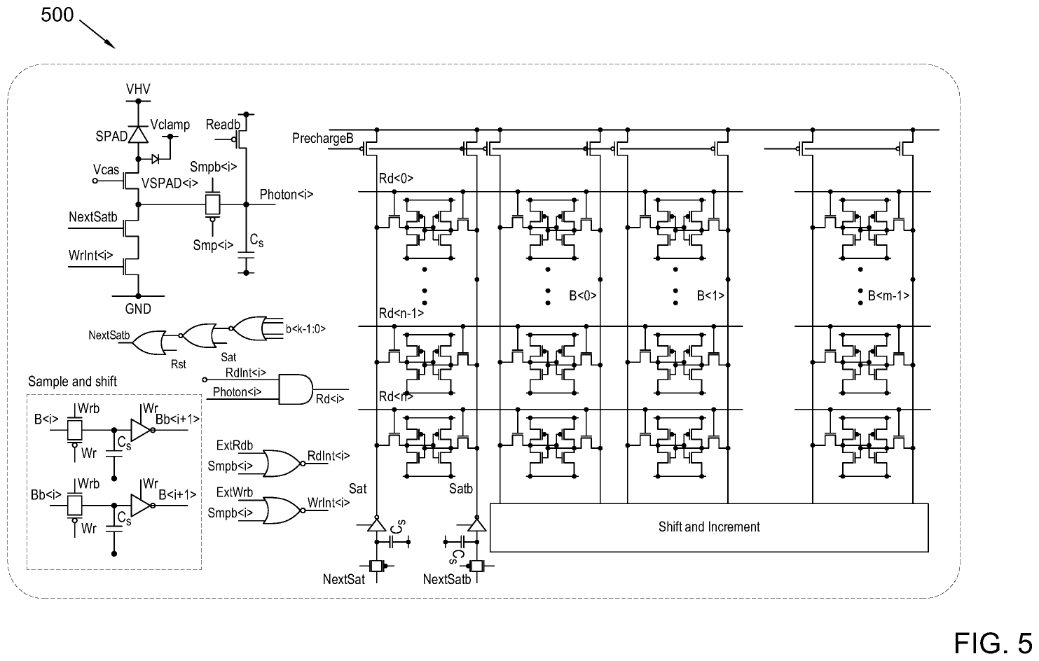

FIG. 5 depicts a circuit diagram of a macropixel implemented using a LFSR and an SRAM, according to a further embodiment of the disclosure;

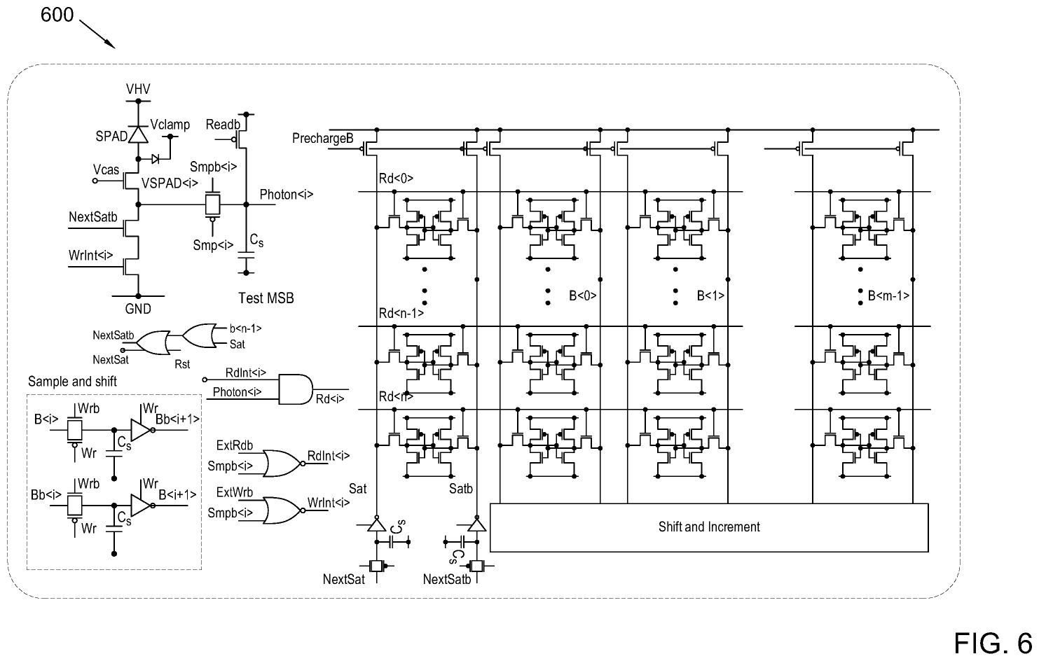

FIG. 6 depicts a circuit diagram of a macropixel implemented using a binary increment circuit and an SRAM, according to a further embodiment of the disclosure;

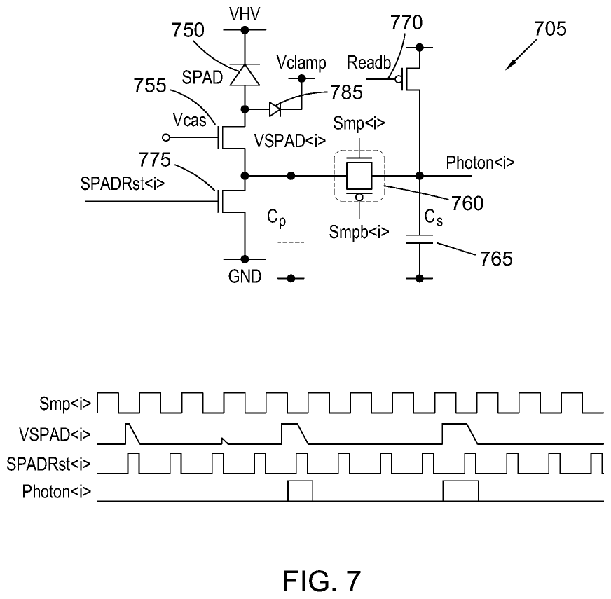

FIG. 7 depicts a pixel for use in a macropixel according to an embodiment of the disclosure, and an associated timing diagram;

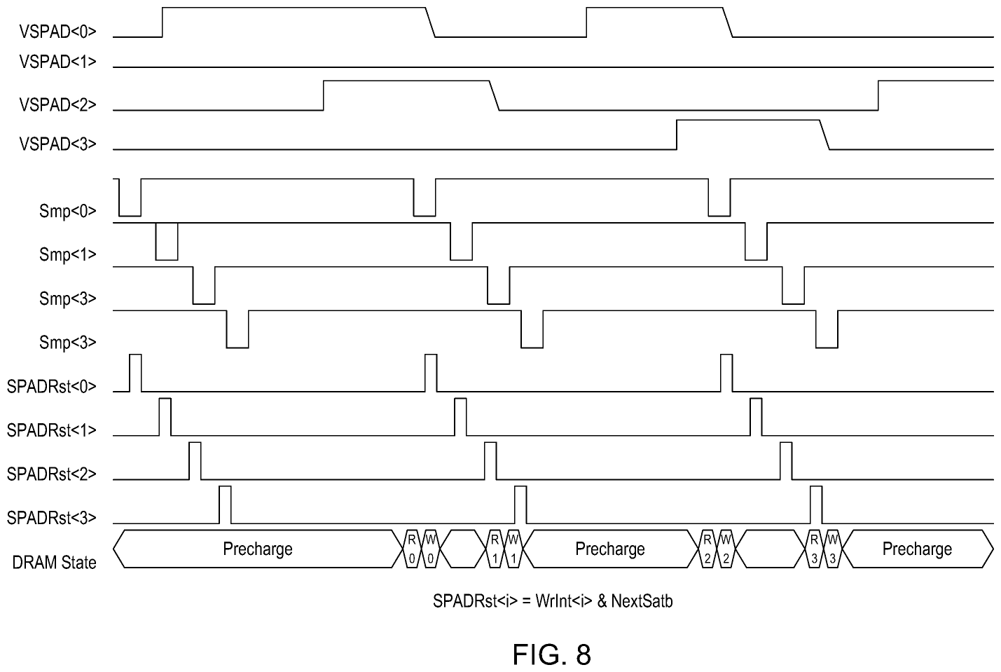

FIG. 8 depicts a timing diagram for a macropixel based on a plurality of the pixels of FIG. 7;

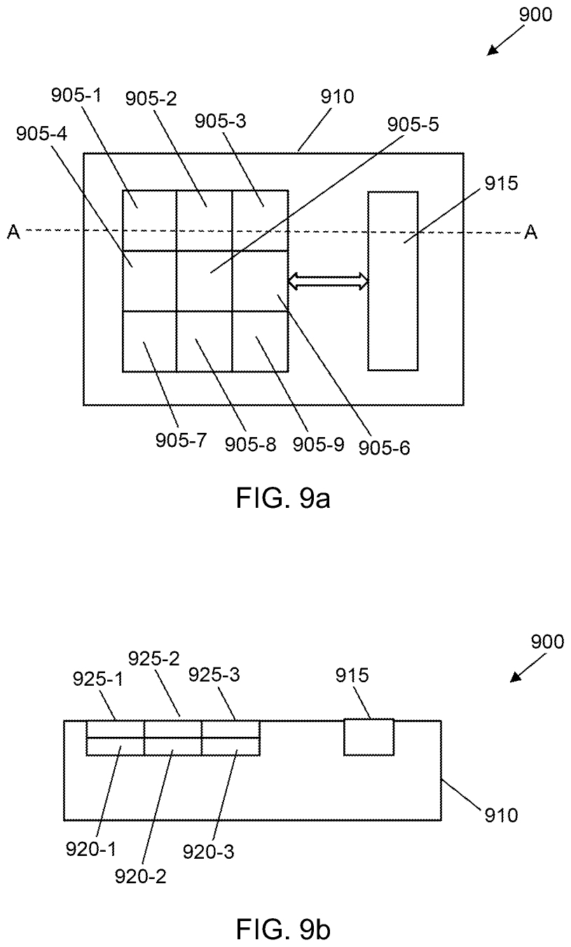

FIG. 9a depicts a sensor comprising a plurality of macropixels, according to an embodiment of the disclosure; and

FIG. 9b depicts a cross-sectional view of the sensor of FIG. 9a.

### DETAILED DESCRIPTION OF THE PREFERRED EMBODIMENTS

FIG. 1 depicts a block diagram of a macropixel 100 according to an embodiment of the disclosure.

The example macropixel 100 comprises a plurality of pixels, namely a first pixel 105a, a second pixel 105b and a third pixel 105c. For purposes of example, only three pixels 105a, 105b, 105c are depicted, although it will be understood that in embodiments of the disclosure as few as two or more than three pixels may be implemented in a macropixel.

Each pixel 105a, 105b, 105c comprises a SPAD and associated circuitry, as described below in more detail with reference to the examples of FIGS. 2 to 7. For example, such associated circuitry may comprise circuitry for sampling and holding a voltage level, circuitry for resetting the SPAD, circuitry for quenching the SPAD, and/or the like, as described in below with reference to the pixel 305 of FIG. 3.

The macropixel 100 also comprises a memory 110. In the example macropixels described with reference to FIGS. 1 to 6, the memory 100 is an SRAM or a DRAM. It will be understood that such memory implementations are provided for purposes of example only, and in other examples the memory 100 may be implemented as another memory type, e.g. a Phase-Change RAM (PCRAM), a Synchronous Dynamic Ram (SDRAM), a spin-torque transfer RAM (STTRAM), or the like.

The memory 110 is configured to store configured to store a plurality of counts, e.g. values that may be used with associated counter circuitry to implement counters. Such counts may be stored as words in the memory 110. In the example, the memory 110 is configured to store: a first count 115a associated with the first pixel 105a; a second count 115b associated with the second pixel 115b; and a third count 115c associated with the third pixel 105c.

In some embodiments, each count 115a, 115b, 115b may correspond to a value for a binary counter, as described in more detail below with reference to the examples of FIGS. 4 and 6.

In some embodiments, each count 115a, 115b, 115b may correspond to a value or code representing a state of a Linear Feedback Shift Register (LFSR), as described in more detail below with reference to the examples of FIGS. 2, 3 and 5.

The memory 110 is also configured to store configured to store a plurality of saturation bits. In the example, the memory 110 is configured to store: a first saturation bit 120a associated with the first count 115a; a second saturation bit 120b associated with the second count 115b; and a third saturation bit 120c associated with the third count 115c.

The macropixel 100 also comprises saturation detection circuitry 125 configured to gate a recharge of each SPAD in each pixel 105a, 105b, 105c based on a state of the respective saturation bit 120a, 120b, 120c. That is, signals 125a, 125b, 125c are provided by the saturation detection circuitry 125 to each pixel 105a, 105b, 105c based on a state of the respective saturation bit 120a, 120b, 120c, to control an operation of each pixel 105a, 105b, 105c.

The macropixel 100 also comprises processing circuitry 130. Although in FIG. 1 the processing circuitry 130 is exemplified as a feature of the macropixel 100, in other examples the macropixel 100 may be coupled to processing circuitry 130 that is not a feature of the macropixel 100 directly. For example, two or more macropixels 100 may be coupled to common processing circuitry 130.

In examples, the processing circuitry 130 may be configured to readout each count 115a, 115b, 115b and each associated saturation bit 120a, 120b, 120c at the end of a frame time.

In examples, the processing circuitry may be configured to readout each count 115a, 115b, 115b by clocking the respective pixel 105a, 105b, 105c for at least a number of cycles corresponding to a number of memory cells associated with the pixel 105a, 105b, 105c, while holding the respective pixel in reset 105a, 105b, 105c.

In examples, the processing circuitry 130 may be additionally configured to readout the saturation bit 120a, 120b, 120c associated with each count 115a, 115b, 115b.

The macropixel 100 may be configured such that access to the memory 100 by each pixel 105a, 105b, 105c may be provided on a time-multiplexed basis, such as a round-robin basis, as described in more detail below.

Operation of the macropixel 100 is described in more detail with reference to the corresponding specific embodiments of FIGS. 2 to 7.

FIG. 2 depicts a block diagram of a macropixel 200 according to a further embodiment of the disclosure

The macropixel 200 comprises a plurality of pixels 205, labelled “N×High-Z SPAD Front-ends”.

The term “SPAD front-end” will be understood to refer to a SPAD-based pixel, e.g. a SPAD together with circuitry associated with that SPAD. For example, such associated circuitry may comprise circuitry for sampling and holding a voltage level, circuitry for resetting the SPAD, circuitry for quenching the SPAD, and/or the like, as described in more detail below. A high-impedance, “High-Z”, state of each pixel is described below with reference to FIG. 3.

The example macropixel 200 comprises a DRAM memory 210. The memory 210 is configured to store configured to store N×counts, e.g. values that may be used with associated counter circuitry 235 to implement counters, each count having M bits. As such, the memory 210 is depicted as an “N×M bit memory”.

The memory 210 is also configured to store configured to store N×saturation bits 220, wherein a saturation bits 220 is associated with each count.

Each count stored in the memory 210 corresponds to a value representing a state of a Linear Feedback Shift Register (LFSR). The example counter circuitry 235 comprises LFSR logic, e.g. logic providing XOR feedback and a shift operation, wherein the counter circuitry 235 is provided to update the counts.

As stated above, implementation of LFSR is provided for purposes of example only, and alternative or additional circuitry may be implemented. That is, a photon count increment circuit may be implemented as a binary counter, a LFSR, or another circuit configured to increment, decrement or otherwise advance or sequence through defined states.

The macropixel 100 also comprises saturation detection circuitry 225 configured to detect if any count of the N×counts has saturated and to set a respective saturation bit 220, and to further gate a recharge of each respective SPAD in each of the N×pixels 205 based on a state of the respective saturation bit 220.

That is, signals (not shown in FIG. 2) are provided by the saturation detection circuitry 225 to each of the N×pixels 205 based on a state of the respective saturation bit 220, to control an operation of each of the N×pixels 205.

Also depicted in FIG. 2 are N×read-write-precharge control circuits 250 for controlling access by the N×pixels 205 to the N×M memory 210, as described in more detail with reference to FIG. 3.

The N×read-write-precharge control circuits 250 provide precharge, read and write signals to the memory 210 to enable updating of the counts stored in the memory 210 based upon reception of a signals ‘Photon <n−1:0>’ received from the respective N×pixels 205. Also depicted are signals ‘Rst<n−1:0>’ for holding the SPAD in each of the N×pixels 205 in reset, as described in below with reference to the more detailed embodiments of FIGS. 3 to 6.

Turning now to FIG. 3, there is depicted a circuit diagram of a macropixel 300 implemented using an LFSR and a DRAM. The circuit diagram of a macropixel 300 generally corresponds to the example macropixel 200 of FIG. 2.

The macropixel 300 comprises N×pixels, although for purposes of illustration only a single pixel 305 is shown. The pixel 305 corresponds to one of the “N×High-Z SPAD Front-ends” of the macropixel 200 of FIG. 2.

The example macropixel 300 comprises a DRAM memory 310. The memory 310 is configured to store configured to store N×counts, e.g. values that may be used with associated counter circuitry 335 to implement counters, each count having M bits. As such, the memory 310 comprises an N×M arrangement of memory cells for storing N×counts, each count having M bits.

In the example of FIG. 3, each memory cell is implemented as a three transistor (3T) cell. It will be appreciated than in other embodiments, each DRAM cell may, for example, be implemented as any of a two, three, or four-transistor configuration. Furthermore, in embodiments the cells may be implemented as either NMOS gain cells or PMOS gain cells. Furthermore, other dense memory types may be implemented, for example 1T1C trench DRAM memory cells.

In the example N×M arrangement of memory cells of FIG. 3, each memory cell includes a first transistor, a second transistor and a third transistor. First and second transistors and are connected in series to a bit line bi<1: k−1>, and a third transistor is connected between an input line bi<0: k−2> and a gate of the first transistor, which effectively acts as a storage node.

A read signal Rd<0: n−1> provides a control signal to the gate of each second transistor, and a write signal Wr<0: n−1> provides a control signal to the gate of each third transistor.

When data is to be read from the cells of a count having bits 0 to n, a read signal Rd<0: n−1> may be asserted and data may be read through the corresponding bit lines bi<1: k−1>.

When the count is incremented, e.g. written, write signal Wr<0: n−1|> may be asserted and the data from the input lines bi<0: k−2> may be written in the corresponding memory cells. Each count may be maintained through cyclical refresh operations of the dram memory cells until a new count is written.

Each count stored in the memory 310 corresponds to a value representing a state of a Linear Feedback Shift Register (LFSR). Counter circuitry 335 comprises XOR feedback logic for implementing the LFSR to sequentially update the counts stored in the memory 310. As shown in FIG. 3, each of the bit lines ‘bi’ is provided to the XOR gate as a feedback signal to increment the LFSR.

The memory 310 also comprises memory cells configured to store N×saturation bits 320, wherein a saturation bit 320 is associated with each count.

First and second transistors of each saturation bit are connected in series to a saturation signal “sat”, and a third transistor of each saturation bit is connected between an input line ‘nextSatb’ and a gate of the respective first transistor of each saturation bit, which effectively acts as a storage node.

The read signal Rd<0: n−1> provides a control signal to the gate of each second transistor of the saturation bits 320, and the write signal Wr<0: n−1> provides a control signal to the gate of each third transistor of the saturation bits 320.

The “nextSatb” signal is generated by saturation detect circuitry 325 configured to detect if any count of the N×counts has saturated and to set a respective saturation bit 320, and to further gate a recharge of each respective SPAD in each of the N×pixels 305 based on a state of the respective saturation bit 320.

Also depicted in FIG. 3 is memory access control circuitry 340 for generating the read signals Rd<0: n−1> and the write signals Wr<0: n−1> to perform increment/decrement of counts and refresh operations, according to some embodiments of the present disclosure.

The example pixel 305 comprises a SPAD 350. As is known in the art, operation of the SPAD 350 is based on a p-n junction of the SPAD 350 being biased beyond its breakdown region, known as operation within a ‘Geiger’ region. A high reverse bias voltage generates a sufficient magnitude of electric field such that a single charge carrier introduced into a depletion layer of the SPAD 350 may induce development of a self-sustaining avalanche current, due to impact ionization caused by one or more incident photons. In use, the avalanche may be ‘quenched’ by a quench circuit to allow the SPAD 350 to then be reset, thereby enabling further detection of photons.

In the example pixel 305, a cathode of the SPAD 350 is coupled to a high voltage supply line, denoted VHV. An anode of the SPAD is coupled to a recharge transistor 355 configurable by a signal Vcas coupled to a gate of the recharge transistor 355 to recharge the SPAD 350.

The example pixel 305 also comprises a transmission gate 360. The transmission gate 360 comprises a pair of transistors configurable by a sample signal ‘Smp’ to couple a voltage VSPAD generated by the SPAD 350 at the recharge transistor 355 to a capacitor 365. The transmission gate 360 and the capacitor 365 effectively act as a sample and hold circuit. The pixel 305 also comprises a sample and hold reset transistor 370 for resetting a voltage at the capacitor 365.

The recharge transistor 355 is gated by a quench transistor 375 and a gating transistor 380 arranged in series. A gate of the quench transistor 375 is controlled by the above-described “NextSatb” signal. A gate of the gating transistor 380 is controlled by a “Wrint<i>” signal generated by the above-described memory access control circuitry 340.

A clamp diode 385 is provided to limit an excess bias voltage generated across the SPAD 350, preventing damage to the SPAD 350 in use.

In use, the pixel 305 may operate in a mode known as “high-impedance quenching”, wherein after the SPAD 350 fires, e.g. after a photon strike event occurs, the pixel 305 is configured to hold the SPAD voltage on its own parasitic capacitance, until the transmission gate 360 is configured to enable the voltage to be transferred to the capacitor 365. That is, the quench transistor 375 and gating transistor 380 may be configured to effectively cut off a quenching path to ground. As such, the pixel 305 may be configured such that after the SPAD 350 fires high, the SPAD 350 retains its state until a subsequent reset, e.g. high impedance quenching.

That is, the pixel 350 is configured as a ‘High-Z SPAD quench and sample and hold pixel’, effectively realising a dynamic D-type sampler in a compact area.

For purposes of example, several alternative embodiments of macro pixels are also disclosed.

FIG. 4 depicts a circuit diagram of a macropixel 400 implemented using a binary increment circuit and a DRAM, according to a further embodiment of the disclosure.

Features of the macropixel 400 generally correspond to those of the macropixel 300 of FIG. 3, and therefore are not described in detail for purposes of brevity.

In contrast to the macropixel 300 of FIG. 3, counter circuitry 435 of the macropixel 400 comprises binary increment or decrement logic instead of logic for implementing an LFSR. As such, each count stored in the memory may by incremented or decremented by the counter circuitry 435. That is, each of the bit lines ‘bi’ is provided to the binary increment or decrement logic as a feedback signal to increment or decrement each count stored in memory.

Furthermore, contrast to the macropixel 300 of FIG. 3, saturation detect circuitry 425 is also different. That is, in the macropixel 400 the “nextSatb” signal is generated by saturation detect circuitry 425 configured to detect if any count of the N×counts has saturated and to set a respective saturation bit 420, and to further gate a recharge of each respective SPAD in each of the N×pixels 405 based on a state of the respective saturation bit 420. Detection of saturation is based on detection of a Most Significant Bit (MSB) carry bit being set, indicating that a respective count has reached a maximum (or if decrementing, a minimum) value.

Selection of an LFSR implementation as depicted in FIG. 3 or a binary increment/decrement implementation as depicted in macrocell 400 may be based on a range of factors.

As described above, an LFSR requires implementation of XOR feedback logic, which in an example may be implemented with approximately 16 transistors (16T), together with logic for a shift operation. This may reduce an overall transistor count of the macropixel relative to a binary increment/decrement implementation. However, an LFSR may require implementation of LFSR-to-binary decode circuitry. Such LFSR-to-binary decode circuitry may be implemented outside a pixel area of the macrocell.

Similarly, a binary increment/decrement may be implemented with a chain of full-adder circuits. This may exhibit disadvantages of a relatively large area overhead compared to an LFSR implementation. An example implementation of binary increment/decrement circuitry may have around 44 transistors per count, i.e. N×44T, and furthermore may exhibit carry chain settling delays.

An area per SPAD of circuitry related to increment/decrement a count and provide saturation detection may be arbitrarily reduced by the degree of sharing between counts, e.g. by the magnitude of N. However, a high N may also incur greater time multiplexing and therefore a lower maximum SPAD count rate and dynamic range.

Thus, design trade-offs between binary and LFSR implementations may be made based upon particular application requirements and a particular CMOS technology node.

FIGS. 5 and 6 generally correspond to FIGS. 3 and 4 respectively, wherein the memory is implemented as an SRAM rather than a DRAM.

FIG. 5 depicts a circuit diagram of a macropixel 500 implemented using a LFSR and an SRAM, according to a further embodiment of the disclosure. Each SRAM cell is implemented as a 6-transistor (6T) SRAM cell. FIG. 6 depicts a circuit diagram of a macropixel 600 implemented using a binary increment/decrement circuit and an SRAM, according to a further embodiment of the disclosure. Each SRAM cell is implemented as a 6T SRAM cell.

A selection between SRAM and DRAM implementations may depend upon, for example, a particular CMOS technology node in which the device is fabricated, and power requirements of a particular application. In either case, implementation of counter circuitry and a count stored in an SRAM or DRAM memory may be substantially more area-efficient than implementation of logic counters, e.g. D-type flip-flop based counters.

For example: an area of 1 bit of high density SRAM implemented in CMOS may be around 1/20th of a single counter D-type flip-flop; an area of 1 bit of 3T Gain-cell DRAM implemented in CMOS may be around 1/40th of a single counter D-type flip-flop; and an area of 1 bit of 1T1C trench DRAM implemented in CMOS may be around 1/100th of a single counter D-type flip-flop.

A more detailed comparison of a logic counter-based solution rather than the disclosed count stored using memory cells, with associated increment/decrement circuitry is as follows.

A logic counter may require 20T per bit using standard logic. Readout circuitry may require a further 4T per bit. Therefore, for an N-bit counter with an additional saturation but, an area per pixel is:

$$Area per pixel = ( 20 + 4 ) ( N + 1 ) T + AFE$$

wherein ‘AFE’ is an area for the Analog Front End of the pixel, e.g. the SPAD device.

In contrast, for an implementation of the disclosed shared-memory based macropixel, wherein the memory is configured to store M×counts, each count having N bits and an associated saturation bit, an area per pixel may be expressed as:

$$Area per pixel = ( ( ( N + 1 ) \times memory bit size \times M ) + ( ( N + 1 ) \times memory increment logic ) + M \times ( Address logic ) \\ ( L F S R , state detect and readout tri - state ) ) / M$$

Assume LFSR, state detect and readout tri-state comprises 12T+12T+4T=28T, and assuming address logic, e.g. memory access control circuitry 340, is 2 NAND+2NOR=16T per pixel, then the area per pixel may be expressed as:

$$Area per pixel = ( N + 1 ) T / 20 + 16 T + ( 16 N + 1 ) T / M + 28 T / M for$$

$$SRAM + AFE$$

Applying this to each of the above memory types, e.g. high density SRAM, 3T gain cell DRAM and 1T1C DRAM, an area per pixel may be expressed as:

$$Area per pixel is ( N + 1 ) T / 20 + 16 T + ( 9 N + 1 ) T / M + 28 T / M for$$

$$high density SRAM + AFE ;$$

$$Area per pixel = ( N + 1 ) T / 40 + 16 T + ( 9 N + 1 ) T / M + 28 T / M for$$

$$3 T gain cell DRAM + AFE ; and$$

$$Area per pixel is ( N + 1 ) T / 100 + 16 T + ( 9 N + 1 ) T / M + 28 T / M for$$

$$1 T 1 C DRAM + AFE .$$

As an example configuration of a macropixel, each count may comprise 12 bits (N=12) and there may be a 16-way sharing of the memory, e.g. 16 counts stored in the macrocell (M=16). Based on this example configuration, and excluding the AFE for each pixel, a total area contribution per pixel would be: 312T for a logic-counter; 31.4T for the SRAM based embodiments of FIG. 5; 24.8T for the 3T gain cell DRAM based embodiments of FIG. 3; and 23.9T for a 1T1C DRAM based embodiment.

Thus, it can be seen that the disclosed embodiments employing shared access to a memory array by pixels may require around ten times less area per pixel than logic-counter based solutions, and therefore may achieve in the region of ten times greater resolution due to increased pixel density.

Operation of the macropixels 300, 400, 500, 600 is as follows.

The disclosed macropixels 300, 400, 500, 600 are aimed at an implementations of SPAD photon counting with digital circuits in an extremely compact, e.g. low die-size, format with low power consumption. As such, the disclosed macropixels 300, 400, 500, 600 may leverage wafer scale 3D-integration of back-side illuminated SPADs disposed above the digital circuits, as described in more detail below with reference to FIG. 9b.

Power consumption of SPAD-array based image sensors may be higher than pinned-photodiode CMOS image sensors because a relatively large charge may be consumed by each SPAD for each detected photon that triggers an avalanche event. This charge may flow through a relatively high bias voltage, thereby increasing the power proportionally.

Power consumption of a SPAD may be managed by holding the SPAD below its reverse-bias breakdown voltage. As such, use of the high gain mode, e.g. operation in the Geiger region, may be used on a relatively low duty cycle in embodiments of the disclosure, wherein the duty cycle is selected such that a minimum time duration high gain mode is provided to achieve a desired Signal-to-Noise Ratio (SNR).

In the example macropixels 300, 400, 500, 600, a target SNR (related to a number of photons and hence count bit depth) may be selected by design, wherein detection of photons may be inhibited when this target count is reached.

This may be achieved using high impedance quench and clocked recharge. The SPAD in each pixel may be repeatedly reset on a clock pulse, whereupon the SPAD may be left above breakdown, e.g. in the Geiger mode, in a high impedance state. When a photon trigger an avalanche effect in the SPAD, the SPAD discharges its own capacitance, thereby taking the excess bias below breakdown, e.g. into the sub-Geiger mode, and thus achieving self-quenching.

The proposed pixel structure, e.g. pixel 305, simultaneously achieves single photon counting with relatively high levels of compactness and with a relatively low power consumption.

The disclosed embodiments rely on principles of time-multiplexed sharing of a count, e.g. count 115a, 115b, 115c, stored in memory cells and time-multiplexed SPAD clocked recharging.

That is, in comparison to prior art SPAD-based sensors, greater pixel compactness may be achieved by the use of three mutually complimentary elements. A first element is a dense memory to hold photon count states for a plurality of pixels, such as the DRAM of the embodiments of FIGS. 3 and 4, the SRAM of the embodiments of FIGS. 5 and 6 or advanced memories such as STT-MRAM, PCRAM or the like.

A second element is time-multiplexed sharing of access and increment logic to memory amongst multiple SPADs.

A third element is increment logic implemented with extremely low-logic overhead such as, for example, the above-described LFSR.

In the disclosed embodiments, time-multiplexed increment of access to the shared memory is conveniently combined with time-multiplexed clocked recharge of the SPAD. This provides a technical advantage over synchronous global recharge of the SPAD matrix in reducing a peak power draw from each SPAD's high voltage supply.

Turning again to the example embodiment of FIG. 3, N×SPADs 305 are configured to share access to the N×M bit memory 310 on a round-robin time-multiplexed basis.

As described-above, each SPAD 305 has an individual recharge transistor 355 and a sample and hold circuit provided by a transmission gate 360 and a capacitor 365. In operation, a state of each SPAD 305, e.g. signal “Photon<N−1:0>”, is sampled and held by the sample and hold circuit, wherein the sample and hold circuit is controlled by a round-Robin control signal “Smp<n−1:0>”.

Immediately after each SPAD state is sampled, the respective SPAD is recharged.

The recharge signal is gated by a saturation bit 320 “sat<N−1:0>” stored for each detector in the memory indicating whether the stored SPAD count has reached saturation. That is, saturation detection circuitry is configured to gate a recharge of each SPAD 305 based on a state of the respective saturation bit 320.

Memory access control circuitry 340, which controls read, write, and precharge operations for accessing the memory 310, uses the sampled state indicated by signal “Photon<N−1:0>” to select a single row i of the memory 310 for increment or decrement corresponding to the round-robin selected SPAD 305.

Each “photon<i>” signal may be used to gate global ExtRdb and ExtWrb clocks to create memory-row-specific Rd<i> and Wr<i> signals which read and write respectively the incremented/decremented state of the i′th SPAD photon count. An increment block, e.g. counter circuitry 335, takes a read state of the photon count b<i> for SPAD i and increments that count to be re-written to row i of the memory.

As described above, in some embodiments the counter circuitry 335 may implement an LFSR and in some embodiments the counter circuitry 435 may comprises binary increment (or decrement) logic.

As described, some features of each macropixel 300, 400, 500, 600 are replicated for each pixel, and some features of each macropixel 300, 400, 500, 600 may be shared by each pixel. For example, each pixel has an associated m bits of memory for storing an associated count. Use of dense memory cell structures, such as 3T DRAM memory cells, may mitigate an area impact of such non-shared features.

Similarly, each pixel 305 has its own recharge and sample circuit. As described above, each pixel 305 may be implemented with as few as six transistors, i.e. the recharge transistor 355, the two transistors to form the transmission gate 360, the sample and hold reset transistor 370 controlled by Rdb, the quench transistor 375, and the gating transistor 380

Other features that are replicated for each pixel 305 include the memory access control circuitry 340. To mitigate an area impact of the memory access control circuitry 340, area-efficient circuits are depicted in the embodiments of FIGS. 3 to 7. For example, for the DRAM-based macrocells 300, 400 the memory access control circuitry 340 comprises pairs of NOR and NAND gates, which may comprise as few as 16 transistors per SPAD. For the disclosed SRAM-based macrocells 500, 600 the memory access control circuitry comprises only a single NAND and a pair of NORs per SPAD.

In example embodiments, saturation detection may be implemented by detecting a final state of the m-bit count.

In the macropixels 300, 400 where an LFSR code is used, an m-input NOR may be used to test for an initial state of the m-bit count being re-encountered.

In the macropixels 500, 600 where a binary count is used, it may be sufficient to test for a Most-Significant Bit (MSB) carry bit from the counter circuitry. This bit may be stored as a saturation bit for each SPAD in an additional memory bit, and readout as an indication of a saturation state.

Thus each SPAD has a memory bit indicating if the photon count reached saturation. If the bit is set then the SPAD is inhibited from being reset and will remain in sub-Geiger mode consuming very little power. This is achieved by a series connection of the Wrint<i> signal indicating the currently addressed SPAD and the nextsatb signal which is generated by detecting saturation of the i^{th} SPADs photon count. Advantageously, the series connection implements a conditional open-drain high-Z recharge of the SPAD without additional logic.

That is, SPADs which have saturated their count are therefore maintained in a high off-state, where they are biased below breakdown voltage thus saving power for pixels with high detection rates.

A power consumption of the pixel may be set by the rate of the ExtRdb and ExtWrb as well as the Smp<N−1:0> signals. These can be set at a minimum frequency related to the DRAM leakage, or at a maximum frequency related to the DRAM update time 1/(N×(TRd+TWr)).

If the saturation bit sat is set the state of the SPAD will always subsequently be sampled high indicating that the SPAD has fired. This will cause the SPAD count to be incremented for every subsequent round-Robin cycle until the end of a frame when the saturation bits for all SPADs are reset. As such, the counter state now indicates the number of round robin refresh cycles from the individual SPAD time of saturation to the end of the frame. From this information i.e. the saturation bit for SPAD i and the counter value for SPAD i, a higher dynamic range photon count may be constructed, without impacting a signal-to-noise ratio. In embodiments, a saturation bit set to 1 may indicates that the count should be interpreted as number of recharge cycles until the end of the frame, rather than number of photon strike events.

That is, while the recharge of one or more SPADs in one or more pixels of the plurality of pixels is gated, the associated one or more counts may be used to indicate a time since the respective saturation bit indicated the count saturated.

If the saturation bit for SPAD i is not set, then the counter value for SPAD i represents a number of detected photons. SPADs with a high count rate will reach saturation faster and be inhibited earlier saving most power.

At the end of the frame, all bits from the memory 310 may be read-out by addressing each memory row in turn. In the LFSR implementations of FIGS. 3 and 4, this may be achieved by simply clocking the each pixel 305 with Rst=1 m times for each respective row of memory cells, and reading the bits from Dout on a output column wire shared by all pixels 305 on a column. This will advantageously have an effect of simultaneously resetting the respective row of memory cells. The saturation bit Dsat associated with each count will also be read-out.

In a binary implementation it may be required to add a tristate gate for each. Readout may be achieved by means of a rolling shutter e.g. a line-by-line readout of the memory.

The macropixel may comprise processing circuitry configured to readout each count and each associated saturation bit at the end of a frame time, e.g. circuitry for addressing each memory row in turn, and reading out each count by clocking the respective pixel for at least a number of cycles corresponding to a number of memory cells associated with the pixel, while holding the respective pixel in reset.

DRAM-based macropixels 300, 400 require refresh operations. In embodiments, this may be implemented with additional logic to cause an increment by 0 if the SPAD 305 did not fire, or add/subtract a predetermined number of extra periodic refresh cycles which increment/decrement the memories by a fixed offset to the output code, which can subsequently be accounted for after readout.

FIG. 7 depicts a pixel 705 for use in a macropixel according to an embodiment of the disclosure, and an associated timing diagram.

In the example pixel 705, a cathode of a SPAD 750 is coupled to a high voltage supply line, denoted VHV. An anode of the SPAD is coupled to a recharge transistor 755 configurable by a signal Vcas coupled to a gate of the recharge transistor 755 to recharge the SPAD 750.

The example pixel 705 also comprises a transmission gate 760. The transmission gate 760 comprises a pair of transistors configurable by a sample signal ‘Smp<i>’ to couple a voltage VSPAD<i> generated by the SPAD 750 at the recharge transistor 755 to a capacitor 765. The transmission gate 760 and the capacitor 765 effectively act as a sample and hold circuit. The pixel 705 also comprises a sample and hold reset transistor 770 for resetting a voltage at the capacitor 765.

The pixel 705 generally corresponds to the pixel 305 of FIG. 3, although rather than comprising a separate quench transistor 375 and gating transistor 380, for purposes of simplicity of illustration only a single quench transistor 775 is depicted. The quench transistor 775 is controlled by a signal “SPADRst<i>”, wherein SPADRst<i>= “WrInt<i> & NextSatb.

The recharge transistor 755 is gated by the quench transistor 775.

A clamp diode 785 is provided to limit an excess bias voltage generated across the SPAD 750, preventing damage to the SPAD 750 in use.

In use, the pixel 705 may operate in a mode known as “high-impedance quenching”, wherein after the SPAD 750 fires, e.g. after a photon strike event occurs, the pixel 705 is configured to hold the SPAD voltage VSPAD<i> on its own parasitic capacitance which is represented as capacitor Cp, until the transmission gate 760 is configured to enable the voltage, i.e. the charge, to be transferred to the capacitor 765. That is, the quench transistor 775 may be configured to effectively cut off a quenching path to ground. As such, the pixel 705 may be configured such that after the SPAD 750 fires high, the SPAD 750 retains its state until a subsequent reset, e.g. high impedance quenching. That is, the pixel 750 is configured as a ‘High-Z SPAD quench and sample and hold pixel’, effectively realising a dynamic D-type sampler in a compact area.

That is, the macropixel using the disclosed pixel 705 may be configured such that when a photon triggers the SPAD, the SPAD discharges its internal capacitance, thereby taking the excess bias voltage of the SPAD below a breakdown voltage.

Operation of the pixel 750 is depicted in the accompanying timing diagram. It can be seen that the signal SPADRst<i> is periodically negated with a relatively low duty cycle, and sample and hold transmission gate 760 is periodically clocked at the same rate, such that a state of the SPAD, e.g. a voltage VSPAD may be periodically sampled, with the pixel remaining in a high-Z quench state when not sampled.

In use, the signal Photon<i> (which as described above may be used to gate global RdInt and WrInt clocks to create memory-row-specific Rd<i> and Wr<i> signals which read and write respectively an incremented state of the i′th SPAD photon count) is held low for a low state of Smp<i>.

Notably, a capacity of the capacitor Cp is substantially larger than a capacity of the capacitor 765, such that charge share on a rising edge of Smp<i> maintains a reset SPAD state.

It can be seen that when the signal SPADRst<i> is high, the SPAD 750 is quenched, e.g. a voltage VSPAD that may be high due to a photon strike event is reset to a low voltage.

It can be seen that if VSPAD is high when the signal Smp<i> is high, then the signal Photon<i> is asserted, indicating a photon strike event.

FIG. 8 depicts a timing diagram of an example of a macropixel comprising four pixels, wherein each pixel operates according to the description of the pixel of FIG. 7. Notably, the round-robin time multiplexing of the pixels is clearly depicted, wherein the SPADRst<i> and smp<i> signals for each pixel are asserted in sequence, thereby enabling round robin sampling of VSPAD<0>, VSPAD<1>, VSPAD<2> and VSPAD<3> in sequence.

Furthermore, the disclosed macropixel configurations enable generation of time resolved information.

For example, it may be assumed that each SPAD in a macropixel reset is held for 1/N^{th} of the cycle time for N-way SPAD sharing. This means that a laser pulse return (from a VSEL or the like) falling in the i^{th} SPADs reset window will generate no signal from distances between i/N and i+1/N of the distance range. As such, this may enable an indirect Time-of-Flight (iToF) style distance calculation.

This may allow either full resolution intensity mode imaging or macropixel based distance imaging where distance can be interpreted. In some examples, it may be possible to achieve both full resolution intensity mode imaging and macropixel based distance imaging where distance can be interpreted, as background light will be unaffected by the reset only time correlated light.

In an example embodiment of a 4×4 macropixel (e.g. 16 pixels) would allow effectively a 16-bin histogram. A distance may be interpreted by a pixel with lowest signal, e.g. lowest count, which does not integrate the return pulse compared to other pixels which integrate it 15/16th of the time.

FIG. 9a depicts a plan view of an example of a sensor 900 comprising a plurality of macropixels 905-1 to 905-9, according to an embodiment of the disclosure. FIG. 9b depicts a cross-sectional view of the sensor 900 along a line A-A.

The sensor 900 may be configured as an image sensor, although as described above, such a sensor may be capable of determining time-resolved information, and thus may additionally or alternatively be configurable to operate as a time-of-flight sensor.

In the example embodiment, the sensor 900 comprises only 9 macropixels 905-1 to 905-9. Each macropixel may be a macropixel 300, 400, 500, 600 as described above.

The macropixels 905-1 to 905-9 are formed on a substrate 910. In the example, the macropixels 905-1 to 905-9 are arranged as a regular array of macropixels. Each macropixel 905-1 to 905-9 comprises a plurality of pixels. As just one example, each macropixel may comprise an array of 4×4 pixels.

In other embodiments, the array of macropixels may be used to implement a ‘megapixel array’, e.g. an array comprising hundreds of thousands or millions of pixels comprising a substantial plurality of macropixels.

Also depicted is processing circuitry 915, which may be configured to read-out the memory arrays of each macropixel 905-1 to 905-9 of the sensor 900.

The macropixel 900 is formed as a monolithic device, e.g. fabricated on a single substrate rather than formed by coupling a plurality of discrete devices.

Due to a compactness of the macrocells 905-1 to 905-9, i.e. because the macrocells correspond to novel macrocells 300, 400, 500, 600, a power consumption of SPADs of each macrocell may be decreased relative to prior art SPAD arrays, because the pitch of the SPADs, and hence capacitance, may be reduced.

Furthermore, when viewed in cross-section as shown in FIG. 9b it can be seen that circuitry, e.g., at least the memory arrays 920-1, 920-2, 920-3, for each macropixel 905-1, 905-2, 905-3 are formed in the substrate 910, and the pixels 925-1, 925-2, 925-3 (or at least the SPADs of the pixels) associated with each macropixel 905-1, 905-2, 905-3 are formed over the respective memory arrays 920-1, 920-2, 920-3. The memory arrays 920-1, 920-2, 920-3 are formed in a region of the substrate 910, and the plurality of pixels 925-1, 925-2, 925-3 are formed directly over the memory arrays 920-1, 920-2, 920-3.

That is, due to the extremely compact dimensions of circuitry in each macropixel 905-1, 905-2, 905-3, the disclosed macropixels 905-1, 905-2, 905-3 may leverage wafer scale 3D-integration of back-side illuminated SPADs disposed above the digital circuits, as depicted in FIG. 9b.

Although the disclosure has been described in terms of preferred embodiments as set forth above, it should be understood that these embodiments are illustrative only and that the claims are not limited to those embodiments. Those skilled in the art will be able to make modifications and alternatives in view of the disclosure, which are contemplated as falling within the scope of the appended claims. Each feature disclosed or illustrated in the present specification may be incorporated in any embodiments, whether alone or in any appropriate combination with any other feature disclosed or illustrated herein.

### REFERENCE NUMERALS

100 macropixel 125a signal
105a first pixel 125b signal
105b second pixel 125c signal
105c third pixel. 130 processing circuitry.
110 memory. 40 200 macropixel
115a first count 205 N×pixels
115b second count 210 memory
115c third count 235 counter circuitry
120a first saturation bit 220 N×saturation bits
120b second saturation bit 45 225 saturation detection circuitry
120c third saturation bit 250 Read-Write precharge control
125 saturation detection circuitry circuits
300 macropixel 760 transmission gate
305 pixel 25 765 capacitor
310 memory 770 sample and hold reset transistor
335 counter circuitry 775 quench transistor
320 saturation bit 785 clamp diode
325 saturation detect circuitry 900 sensor
340 memory access control circuitry30 905-1 macropixel
905-2 macropixel 350 SPAD
355 recharge transistor 905-3 macropixel
360 transmission gate
905-4 macropixel
905-5 macropixel
365 capacitor
370 sample and hold reset transistoß5 905-6 macropixel
375 quench transistor
905-7 macropixel
905-8 macropixel
905-9 macropixel
380 gating transistor
385 clamp diode
400 macropixel 910 substrate
425 saturation detect circuitry 40 915 processing circuitry
435 counter circuitry 920-1 memory array
500 macropixel 920-2 memory array
600 macropixel 920-3 memory array
925-1 pixels 705 pixel
750 SPAD 45 925-2 pixels
755 recharge transistor 925-3 pixels

1. A macropixel comprising:
a plurality of pixels, each pixel comprising a Single Photon Avalanche Diode (SPAD);
a memory configured to store:
a plurality of counts, each count associated with a pixel of the plurality of pixels; and
a plurality of saturation bits, each saturation bit associated with a count of the plurality of counts; and
saturation detection circuitry configured to gate a recharge of each SPAD based on a state of the respective saturation bit.

2. The macropixel of claim 1, wherein the saturation detection circuitry is configured to gate a recharge of each SPAD when the respective saturation bit indicates the associated count has saturated.

3. The macropixel of claim 1 wherein: while the recharge of one or more SPADs in one or more pixels of the plurality of pixels is gated, the associated one or more counts is/are used to indicate a time since the respective saturation bit indicated the count saturated; and
while the recharge of one or more SPADs in one or more pixels of the plurality of pixels is not gated, the associated one or more counts is/are used to indicate a number of detected photons.

4. (canceled)

5. The macropixel of claim 1, wherein; access to the memory by each pixel is provided on a time-multiplexed basis; and/or
each SPAD is recharged on a time-multiplexed basis while recharging of the SPAD is not gated,
and optionally wherein the time-multiplexed basis is a round-robin basis.

6. (canceled)

7. (canceled)

8. The macropixel of claim 1, wherein gating the recharge of each SPAD comprises configuring at least one transistor in the respective pixel to retain the SPAD in a sub-Geiger mode.

9. The macropixel of claim 1, wherein each pixel comprises at least one transistor configurable to hold the respective SPAD in a high impedance state while the SPAD is biased in a Geiger mode.

10. The macropixel of claim 1, configured such that when a photon triggers a SPAD, the SPAD discharges its internal capacitance, thereby taking the excess bias voltage of the SPAD below a breakdown voltage.

11. The macropixel of claim 1, wherein each pixel comprises:
a recharge transistor configurable to recharge the respective SPAD to the Geiger mode; and
a sample and hold circuit for sampling and holding a voltage corresponding to a state of the respective SPAD.

12. The macropixel of claim 1, comprising a shared and time-multiplexed memory increment or decrement circuit configured to increment or decrement each count of the plurality of counts.

13. The macropixel of claim 1, wherein each count corresponds to:
a value for a binary counter; and/or
a value representing a state of a Linear Feedback Shift Register (LFSR).

14. (canceled)

15. The macropixel of claim 1, comprising processing circuitry configured to readout each count and each associated saturation bit at the end of a frame time.

16. The macropixel of claim 1, wherein the processing circuitry is configured to readout each count by clocking the respective pixel for at least a number of cycles corresponding to a number of memory cells associated with the pixel, while holding the respective pixel in reset, and optionally wherein the processing circuitry is additionally configured to readout the saturation bit associated with each count.

17. (canceled)

18. The macropixel of claim 1 wherein, when the saturation bit associated with a respective count is set and when a recharge of the associated SPAD is gated, the processing circuitry is configured to use the respective count as an indication of round-robin refresh cycles since the saturation bit was set.

19. The macropixel of claim 1, wherein the memory comprises an array of Static Random Access Memory (SRAM) cells.

20. The macropixel of any of claim 1, wherein the memory comprises an array of Dynamic Random Access Memory (DRAM) cells.

21. The macropixel of claim 20, comprising refresh circuitry for refreshing the DRAM cells, wherein the refresh circuitry is configured to:
increment the count by zero if the respective SPAD has not been triggered; or
add a predetermined number of extra refresh cycles to the count for subsequent subtraction by processing circuitry.

22. The macropixel of claim 1, formed as a monolithic device.

23. The macropixel of claim 1, wherein:
the memory is formed in a region of a substrate; and
the plurality of pixels are formed directly over the memory.

24. An image sensor comprising an array of macropixels according to claim 1.

25. A proximity sensor or a time-of-flight sensor comprising at least one macropixel according to claim 1.
